(19) United States
(12) Patent Application Publication
(10) Pub. No.: US 2011/0307737 A1
(43) Pub. Date: Dec. 15, 2011

(54) STATE DISPLAY APPARATUS, PROGRAM AND STATE DISPLAY SYSTEM

(75) Inventor: Satoshi Uchino, Koganei-shi (JP)

(73) Assignee: KABUSHIKI KAISHA TOSHIBA, Tokyo (JP)

(21) Appl. No.: 13/079,680

(22) Filed: Apr. 4, 2011

(30) Foreign Application Priority Data
Jun. 9, 2010 (JP) 2010-132164

(51) Int. Cl. G06F 11/07

(52) U.S. Cl. 714/15; 714/E11.023

(57) ABSTRACT

According to one embodiment, a state display apparatus comprises a receiving module configured to receive measurement files includes item data representing items executed by an object device to be measured, state-change data representing changes in the state of the items and time data, a storage module configured to store the states of the items of the object device in a form of a stack structure for each items, based on the measurement files received by the receiving module, a display module configured to display the states of the items, which are stored in the storage module, and a display controller configured to erase the state of at least one of the states of the items, stored in the form of the stack structure by the storage module, when the measurement files received by the receiving module comprise error data.

### CROSS-REFERENCE TO RELATED APPLICATIONS

This application is based upon and claims the benefit of priority from Japanese Patent Application No. 2010-132164, filed Jun. 9, 2010; the entire contents of which are incorporated herein by reference.

### FIELD

Embodiments described herein relate generally to a state display apparatus, a program and a state display system.

### BACKGROUND

State display apparatuses designed to display the operating states of computers have hitherto been used in general. The state display apparatus generates trace data from the operating state of an object apparatus. On the basis of the trace data generated, the state display apparatus can display the state of the computer (i.e., object to be measured).

The state display apparatus stores the trace data in, for example, a buffer such as a ring buffer. The state display apparatus reads the trace data stored in the ring buffer, and generates a file (measurement file) of trace data about the object to be measured.

The state display apparatus may record, as trace data, the changes in state for every process item (i.e., process) performed in the object to be measured. In this case, the state display apparatus can display the state the object measured has while performing each process item.

Further, the state display apparatus can manage the changes in state for a certain process item, in the form of a stack structure, thereby to display the state the object had while performing the immediately preceding process item.

The trace data may not be read from the ring buffer as fast as new trace data is written into the ring buffer. If this is the case, the ring buffer may overflow. Once the ring buffer has overflowed, the changes in the operating state about the process item can no longer be correctly contained in the trace data. Consequently, the state display apparatus may make an error, failing to display the state of the object correctly.

### BRIEF DESCRIPTION OF THE DRAWINGS

A general architecture that implements the various features of the invention will now be described with reference to the drawings. The drawings and the associated descriptions are provided to illustrate the embodiments and not to limit the scope of the invention.

FIG. 1 is an example view for explaining a state display system according to an embodiment.

FIG. 2 is an example view for explaining the functions of the state display system according to an embodiment.

FIG. 3 is an example view for explaining process of an object apparatus according to an embodiment.

FIG. 4 is an example view for explaining measurement file according to an embodiment.

FIG. 5 is an example view for explaining state management data according to an embodiment.

FIG. 6 is an example view for explaining measurement file according to an embodiment.

FIG. 7 is an example view for explaining process of the object apparatus according to an embodiment.

FIG. 8 is an example view for explaining process performed in the state display system according to an embodiment.

FIG. 9 is an example view for explaining process performed in the state display system according to an embodiment.

FIG. 10 is an example view for explaining process performed in the state display system according to an embodiment.

FIG. 11 is an example view for explaining state management data according to an embodiment.

FIG. 12 is an example view for explaining process performed in the state display system according to an embodiment.

FIG. 13 is an example view for explaining process performed in the state display system according to an embodiment.

### DETAILED DESCRIPTION

Various embodiments will be described hereinafter with reference to the accompanying drawings. In general, according to one embodiment, a receiving module configured to receive measurement files comprising item data representing items executed by an object device to be measured, state-change data representing changes in the state of the items and time data, a storage module configured to store the states of the items of the object device in a form of a stack structure for each items, based on the measurement files received by the receiving module, a display module configured to display the states of the items, which are stored in the storage module, and a display controller configured to erase the state of at least one of the states of the items, stored in the form of the stack structure by the storage module, when the measurement files received by the receiving module comprise error data.

A state display apparatus, a program and a state display system, all according to a first embodiment, will be described with reference to the accompanying drawings.

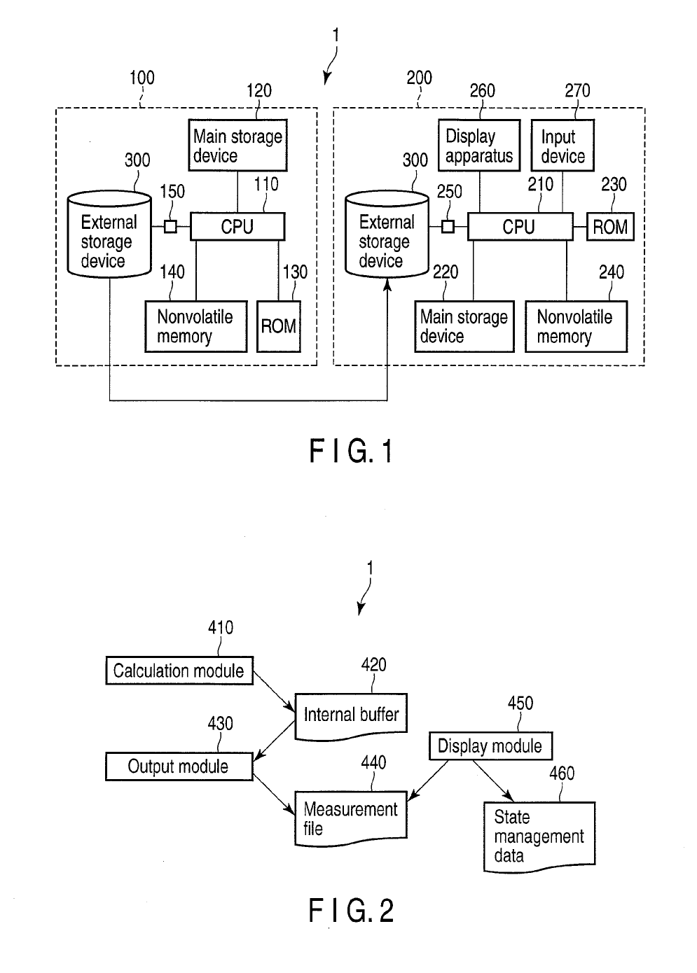

FIG. 1 is a diagram showing an example configuration of a state display system according to the first embodiment.

The state display system 1 comprises a processing apparatus 100 and a state display apparatus 200. The processing apparatus 100 is an object whose operating state should be measured. The state display apparatus 200 is configured to display the state of the processing apparatus 100.

The processing apparatus 100 comprises a CPU 110, a main storage device 120, a ROM 130, a nonvolatile memory 140, and an interface 150.

The CPU 110 has an operation element that performs various operations. The CPU 110 executes the programs stored in the ROM 130 or the nonvolatile memory 140, thereby implementing various function modules.

The processing apparatus 100 may comprise hardware that performs a function equivalent to that of the function modules, instead of the programs stored in the nonvolatile memory 140.

The main storage device 120 functions as work memory for the CPU 110. That is, the CPU 110 temporarily stores the data read from the ROM 130 or nonvolatile memory 140 and the data to be written into an external storage device 300 (described later), etc.

The ROM 130 holds a control program for controlling the processing apparatus 100. The ROM 130 stores process programs for executing applications, etc. The nonvolatile memory 140 is a memory storing various present data items.

The interface 150 is an interface that can connect various devices. The interface 150 has, for example, a memory reader/writer. The memory reader/writer can connect various storage media such as USB port, S_ATA port, LAN port, and memory reader/writer.

The external storage device 300 is a storage device such as HDD, UBS memory or a memory card. The external storage device 300 is connected to the interface 150 of the processing apparatus 100. The CPU 110 can therefore write and read data into and from the external storage device 300, and can also perform other processes. That is, the external storage device 300 functions as a receiving module configured to receive various data items. The external storage device 300 may be of any type of a nonvolatile storage medium.

The state display system 1 may have a communication interface that connects the processing apparatus 100 and the state display apparatus 200 to each other. If this is the case, the external storage device 300 can be replaced by a storage device incorporated in the processing apparatus 100.

The CPU 110 executes the program stored in the ROM 130 or nonvolatile memory 140, or hardware equivalent to this program, thereby activating various items (processes). These processes enter various states (hereinafter referred to as “state entrances”) or exit from various states (hereinafter referred to as “state exits”).

The CPU 110 performs a specific process (described later), storing the state entrance and state exit of each item and generating a file of trace data (measurement file).

The state display apparatus 200 comprises a CPU 210, a main storage device 220, a ROM 230, a nonvolatile memory 240, an interface 250, a display apparatus 260 and an input device 270, in addition to the external storage device 300.

The CPU 210 has an operation element that performs various operations. The CPU 210 executes the programs stored in the ROM 230 or the nonvolatile memory 240, thereby implementing various function modules.

The state display apparatus 200 may comprise hardware that performs a function equivalent to that of the function modules, instead of executing the programs stored in the nonvolatile memory 240.

The main storage device 220 functions as work memory for the CPU 210. That is, the CPU 210 temporarily stores the results of operations in the main storage device 220. Further, the CPU 210 temporarily stores, in the main storage device 220, the data read from the ROM 230 or nonvolatile memory 240 and the data read from the external storage device 300, etc. Still further, the CPU temporarily stores the data to be written into the external storage device 300, in the in the main storage device 220.

The ROM 230 holds a control program for controlling the state display apparatus 200. The ROM 230 stores process programs for executing applications, etc. The nonvolatile memory 240 is a memory storing various present data items.

The interface 250 is an interface that can connect various devices. The interface 250 has, for example, a memory reader/writer. The memory reader/writer can connect various storage media such as USB port, S-ATA port, LAN port, and memory reader/writer.

Thus, the external storage device 300 connected to the processing apparatus 100 can be connected to the interface 250 of the state display apparatus 200. As long as the external storage device 300 remains connected to the interface 250 of the state display apparatus 200, the CPU 210 can write and read data into and from the external storage device 300 and can perform any other process.

The display apparatus 260 is, for example, a liquid crystal display or an organic EL display. Alternatively, the display apparatus 260 may be any other type of a display module, which can display images represented by video signals. The display apparatus 260 displays the image represented by any signal it has received from the CPU 210.

The input device 270 is an input module that has keys, a keyboard, a mouse, or an input device of any other type, which can generate operation signals when operated. If operated, the input device 270 generates operation signals. The operation signals are supplied to the CPU 210.

The CPU 110 and the CPU 210 may have a register each. In this case, any data that may be frequently referred to is stored in the register, not in the main storage device 120 or in the main storage device 220.

FIG. 2 is an example diagram explaining the functions of the state display system 1 of FIG. 1.

The state display system 1 has various modules and a storage area for storing data. The modules are activated by either the CPU 110 of the processing apparatus 100 or the CPU 210 of the state display apparatus 200.

More precisely, the state display system 1 has a calculation module 410, an internal buffer 420, an output module 430, a storage area for storing a measurement file 440, a display module 450, and a storage area for storing state management data 460.

In this embodiment, the processing apparatus 100 has the calculation module 410, internal buffer 420 and output module 430, and the state display apparatus 200 has the display module 450 and the storage area for storing state management data 460. The embodiment is not limited to this configuration, nevertheless. Each function shown in FIG. 2 may be provided in either the processing apparatus 100 or the state display apparatus 200. Moreover, the processing apparatus 100 and the state display apparatus 200 may be formed integral with each other.

Thus, as shown in FIG. 2, the state display system 1 comprises the measuring module 410, internal buffer 420, output module 430, storage area for storing a measurement file 440, a display module 450 and storage area for storing state management data 460.

The measuring module 410 measures the state transition of each item at the state entrance and state exit. The measuring module 410 has at least a function of counting time and a function of recognizing the state in which the object is performing a process. That is, if the state changes while the CPU 110 is performing an item, the measuring module 410 stores into the internal buffer 420 trace data including the name of the item, the time at which the state has changed, and the content of the state.

The internal buffer 420 is a ring buffer allocated to, for example, the main storage device 120.

The output module 430 reads the trace data from the internal buffer 420 and stores the same, as a file, in the external storage device 300. In other words, the output module 430 generates the measurement file 440 in the external storage device 300.

The CPU 110 recognizes a write location and a read location at which data has been written and read, respectively, in the internal buffer 420. At the write location the CPU 110 has recognized, the measuring module 410 starts writing the trace data. The measuring module 410 moves a write pointer indicating the write location, to the end of the trace data so written.

The output module 430 starts reading the trace data at the read location the CPU 110 has recognized. The output module 430 moves a read pointer indicating the read location, to the end of the trace data so read.

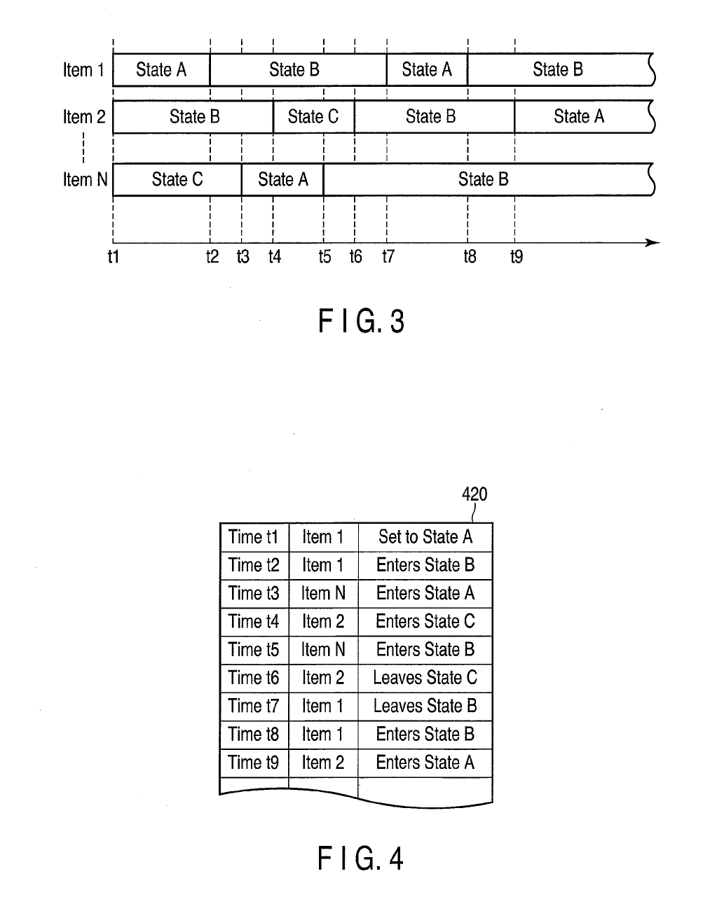

FIG. 3 is an example timing chart explaining how the object to be measured performs process items in the state display system 1.

As seen from FIG. 3, the CPU 110 executes the program stored in the ROM 130 or the nonvolatile memory 140, or executes the hardware equivalent to the program, thereby starting items 1 to N.

In the case shown in FIG. 3, the item 1 is set to state A at time t1, the item 2 stays in state B at time t1, and the item N stay stays in state C at time t1.

The item 1 enters state B at time t2. The item N enters state A at time t3. The Item 2 enters state C at time t4. The item N enters state B at time t5. The item 2 exits from state C at time t6. The item 1 that exited from state B at time t7 enters state B at time t8. The item 2 enters state A at time t9.

If the CPU 110 performs the process as shown in FIG. 3, the measuring module 410 will store the trace data representing the state changes of the items, into the internal buffer 420. The output module 430 sequentially reads the trace data stored in the internal buffer 420. Then, the output module 430 generates, from the trace data, such a measurement file 440 as shown in FIG. 4, in the external storage device 300.

As seen from FIG. 4, the measurement file 440 includes “time,” “item” and “data indicating a state change (state-change data).” In the measurement file 440, the “time,” “item” and “state-change data” are stored, each associated with any other. Note that the state-change data represents a change at the state entrance, a change at the state exit, or any other change.

The display module 450 shown in FIG. 2 controls a data-displaying process. The display module 450 can display the state of each item being executed in the object, by using the data contained in the measurement file 440.

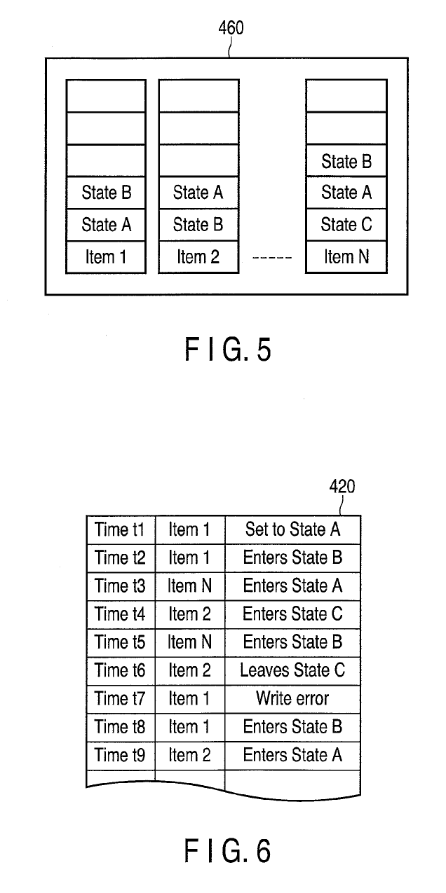

The display module 450 reads the trace data stored in the measurement file 440. The display module 450 then generates such state management data 460 as shown in FIG. 5, from the trace data thus read, in, for example, the main storage device 220. The display module 450 may generate the state management data 460 in the nonvolatile memory 240, not in the main storage device 220.

The state management data 460 holds data of stack structure. The state management data 460 contains the history of state changes accumulated for each process item. Any state change received and indicating a state entrance is added to the stack structure of the state management data 460. (The addition shall be called “PUSH.”) Further, any state change received and indicating a state exit is extracted and erased. (The deletion shall be called “POP.”) If the erased state is not identical to the state indicated by the state exit at this point, an error is made in the state display apparatus 200. Note that FIG. 5 is a table representing an example of state management data 460, which has been acquired at time t9.

In the state management data 460 of FIG. 5, the item 1 has data representing first “state A,” next “state B,” etc., sequentially accumulated from bottom to top. The item 2 has states sequentially accumulated from bottom to top, first “state B,” next “state A,” etc. The item N has states sequentially accumulated from bottom to top, first “state C,” next “state A,” then “state B,” etc. Note that the user can access the top state.

In this case, “state B” may be subjected to POP for the item 1. Then, “state A” will be the top state for the item 1 if the item 1 exits from the state B.

The display module 450 may cause, for example, the display apparatus 260 to display the state management data 460 (FIG. 5) generated in the main storage device 220. The display module 450 can then inform the user of the state of the object. The display module 450 may be configured to cause a display, if any connected to the interface 250, to display such state management data 460 as shown in FIG. 5.

The state management data 460 may be saved in the form of a list or the like. Further, the display module 450 may be configured to display such a timing chart as shown in FIG. 3, in which time is plotted on the horizontal axis.

FIG. 6 is a table representing another example of a measurement file 440 generated in the state display system 1 of FIG. 1. More precisely, FIG. 6 shows an example of the measurement file 440, which is generated if the internal buffer 420 overflows.

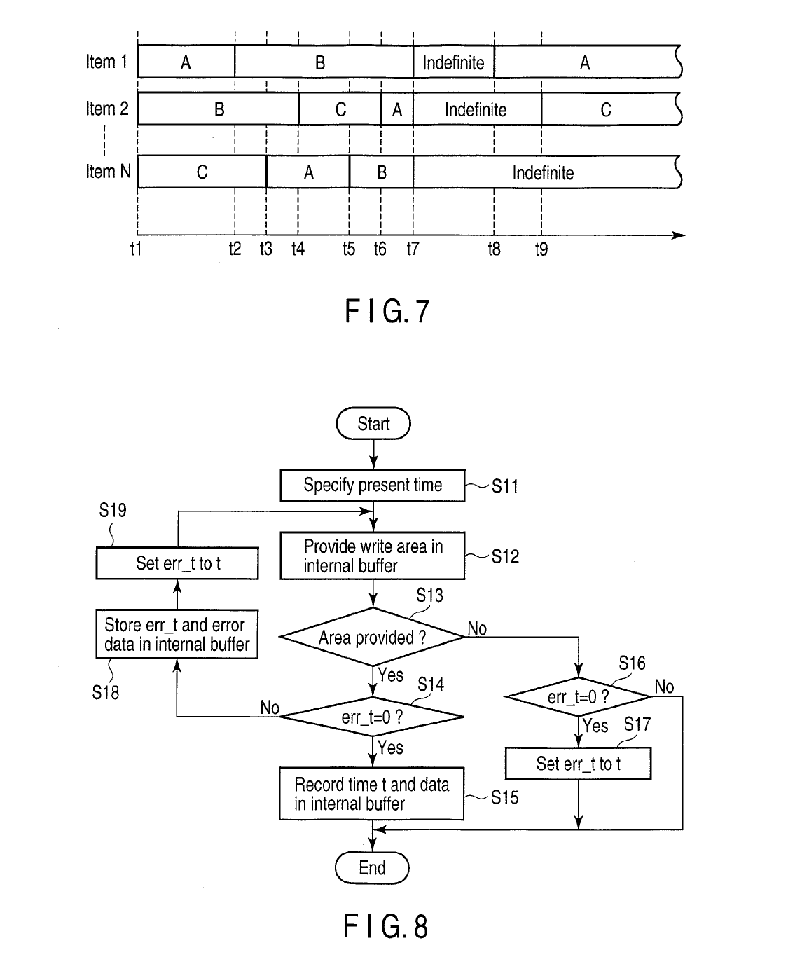

Assume that the internal buffer 420 overflows when the trace data about the item 1 is written at time t7 into the internal buffer 420, as illustrated in FIG. 7. Then, a write error is made. The measuring module 410 temporarily stores the time (err_t) when the error is made, the item 1, and the data (error data) representing that a write error has been made, in a storage area available in the main storage device 120, in the register provided in the CPU 110 or in any other storage area. Note that the time (err_t) is initially set to “0”.

If the position of a read pointer and the position of a write pointer show that the internal buffer 420 has a sufficient write area, the measuring module 410 writes the data representing the time (err_t), the item and the data representing that an error has been made, as trace data, into the internal buffer 420. As a result, such a measurement file 440 as shown in FIG. 6 is generated. That is, the measuring module 410 writes the error time, as “time,” into the internal buffer. The measuring module 410 also writes the error data, as “state change data,” into the internal buffer.

If the display module 450 generates state management data 460 from such measurement file 440 shown in FIG. 6, it cannot recognize any state changes that occurs after the trace-data writing error is made until the trace-data writing becomes possible. Therefore, the state change is not reflected in the state management data 460 or in the data displayed.

This is why the display module 450 clears all items when a trace-data writing error is made.

The display module 450 determines that any item for which no state is subjected to PUSH assumes “indefinite state.” In other words, the display module 450 determines that any item for which no state is subjected to PUSH does not assume a specific state at all.

Moreover, after clearing all items, the display module 450 subjects an item to PUSH or POP in accordance with the trace data correctly written in the measurement file 440. Therefore, a state different from the state the object actually assumes can be prevented from being displayed in the state display system 1.

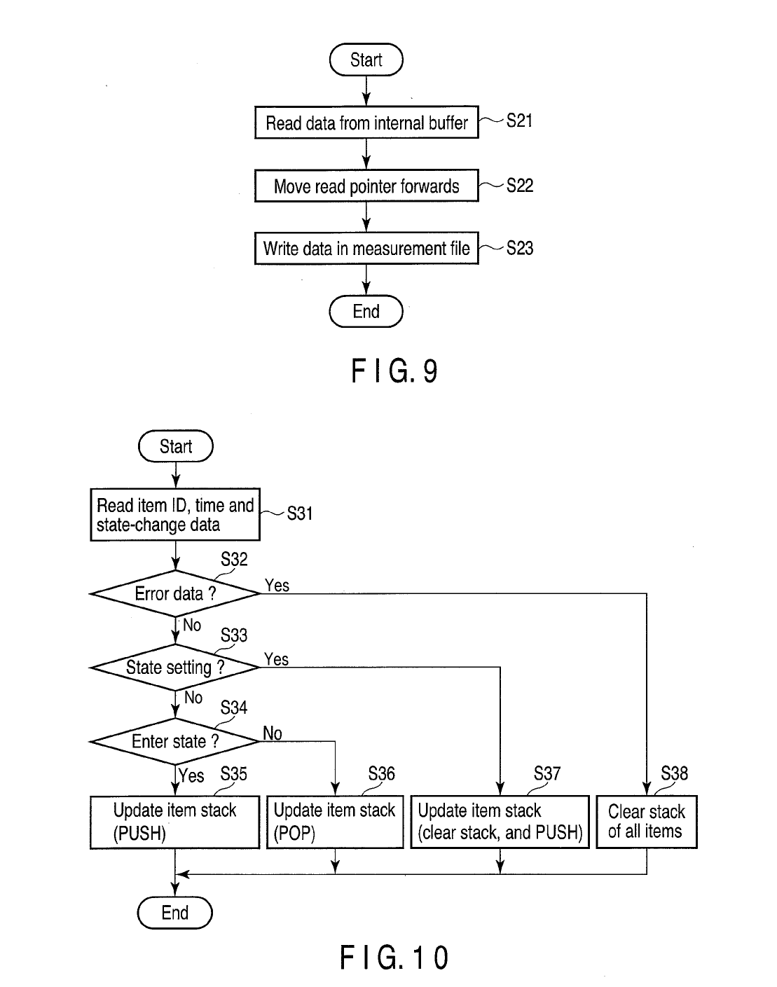

FIG. 8, FIG. 9 and FIG. 10 are flowcharts explaining processes performed in the state display system 1. FIG. 8 is a flowchart explaining how the measuring module 410 performs a process.

Assume that in an object apparatus such as the processing apparatus 100, the CPU 110 performs at least one process. Then, the measuring module 410 recognizes a state change during the process the object is performing.

In Step S11, the measuring module 410 specifies the present time t. In Step S12, the measuring module 410 provides a write area in the internal buffer 420.

The measuring module 410 determines, in Step S13, whether the write area available in the internal buffer 420 is large enough to hold the trace data (measurement data) that should be written in the internal buffer 420. Note that the amount of the measurement data is preset or determined from the content of the data to be written as measurement data.

If the measuring module 410 determines that the write area available in the internal buffer 420 is large enough to hold the measurement data, it determines, in Step S14, whether the time (err_t) at which an error has been made is “0” or not. If err_t is “0,” the measuring module 410 writes, in Step S15, the measurement data and the time t into the internal buffer 420. More precisely, the measuring module 410 writes “time,” “item” and “state change data” into the internal buffer 420. Then, the measuring module 410 terminates the process.

In Step S13, the measuring module 410 may determine that the write area available in the internal buffer 420 is not enough to hold the measurement data. If this is the case, the measuring module 410 determines, in Step S16, whether err_t is “0” or not.

If err_t is found to be “0” in Step S16, the measuring module 410 sets err_t to time t in Step S17. Then, the measuring module 410 terminates the process. If err_t is found not to be “0,” the measuring module 410 terminates the process, without changing err_t.

In Step S14, the measuring module 410 may determine that err_t is not “0.” In this case, the measuring module 410 writes, in Step S18, time t and the error data into the internal buffer 420. More precisely, the measuring module 410 writes “error time,” “item” and “data representing an error made” into the internal buffer 420. Further, the measuring module 410 sets err_t to “0” in Step S19, and then goes to Step S12.

FIG. 9 is a flowchart explaining the process the output module 430 performs to generate a measurement file 440.

The output module 430 reads, in Step S21, “time,” “item” and “state change data” from the internal buffer 420. In Step S22, the output module 430 moves the read pointer indicating a read position, in accordance with the read area from which to read data. That is, the output module 430 moves the read pointer to the end of the trace data that has been read.

In Step S23, the output module 430 generates a measurement file 440 from “time,” “item” and “state change data” read from the internal buffer 420. If the measurement file 440 has already been generated, the output module 430 adds, to the measurement file 440, the data based on the trace data, i.e., “time,” “item” and “state change data.”

FIG. 10 is a flowchart explaining the data-displaying process the display module 450 performs.

To display the state of the object, the display module 450 reads, in Step S31, “time,” “item” and “state change data,” etc. from the measurement file 440.

In Step S32, the display module 450 determines whether “state change data” is error data or not.

Then, in Step S33, the display module 450 determines whether the “state change data” represents a state setting. In other words, the display module 450 determines whether the state of the item has been initialized or not.

Further, in Step S34, the display module 450 determines whether “state change data” represents that the item should “enter a certain state” (or pushed to a certain state).

If the “state change data” is found, in Step S34, to represent that the item should “enter a certain state,” the display module 450 updates, in Step S35, the state of the stack of the item corresponding to the “item” read from the state management data 460. That is, the display module 450 subjects the state represented by the “state change data” to PUSH, for the item that corresponds to the “item” read from the state management data 460.

If the “state change data” is not found, in Step S34, to represent that the item should “enter a certain state,” the display module 450 determines that the “state change data” represents that the subject apparatus exits from a certain state. In this case, the display module 450 goes to Step S36, in which it updates the state of the stack of the item corresponding to the “item” read from the state management data 460. That is, the display module 450 subjects the state represented by the “state change data” to POP, for the item that corresponds to the “item” read from the state management data 460.

In Step S33, the “state change data” may be found to represent a state setting. If this is the case, the display module 450 updates, in Step S37, the state of the stack of the item corresponding to the “item” read from the state management data 460. That is, the display module 450 clears the item accumulated in the “item” read, and then subjects the state represented by the “state change data” to PUSH.

The display module 450 may determine, in Step S32, that the “state change data” is error data. In this case, the display module 450 clears, in Step S38, the item accumulated in the items accumulated in all items of the state management data 460.

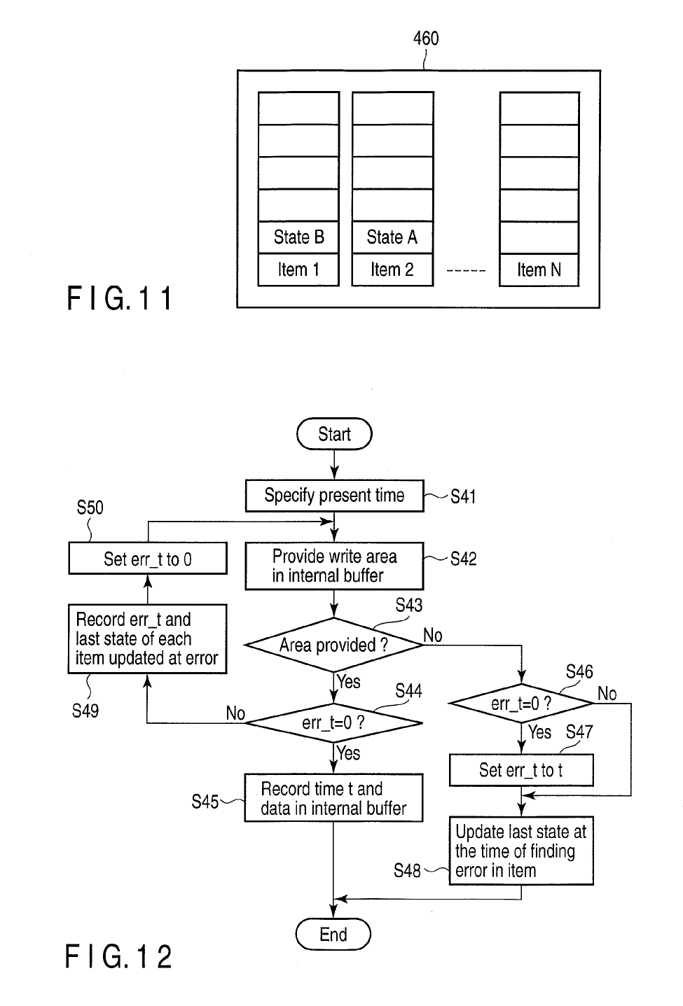

For example, the display module 450 causes the display apparatus 260 to display such state management data 460 as shown in FIG. 11, so that the above-mentioned process may be performed in accordance with the measured file 440 shown in FIG. 6, thereby to display the state of the object apparatus.

In the state management data 460 shown in FIG. 11, the items accumulated before time t7 have been cleared, because an error has been made at time t7. Therefore, the display module 450 subjects the state B to PUSH, setting the state B to the item 1 at time t8, after the buffer overflow has been eliminated. Further, the display module 450 subjects the state A to PUSH, setting the state A to item 2 at time t9.

As a result, the item 1 assumes a state in which “state B” is accumulated as is illustrated in FIG. 11. The item 2 assumes a state in which “state A” is accumulated. The item N assumes an indefinite state because no items are accumulated at all.

As described above, the state change data accumulated as a stack is cleared in the state display system 1 according to the first embodiment, if a write error is made due to, for example, the buffer overflow. This prevents the display apparatus 260 from displaying any state at the top item of the stack and from displaying a state different from the state of the process the object is performing. The first embodiment can therefore provide a state display apparatus, a program and a state display system, all having high reliability.

In the embodiment described above, any object whose state should be measured is called “item.” Nonetheless, an object can be anything whose state change can be described as a stack structure. For example, objects may be replaced by the processes included in the operating system. If so, each item (process) has a name or an identifier (ID). In the operating system, each item (process) is identified with the name or identifier assigned to it.

In the embodiment described above, all items are cleared if a buffer overflow takes place. Nonetheless, the state display system is limited to this configuration.

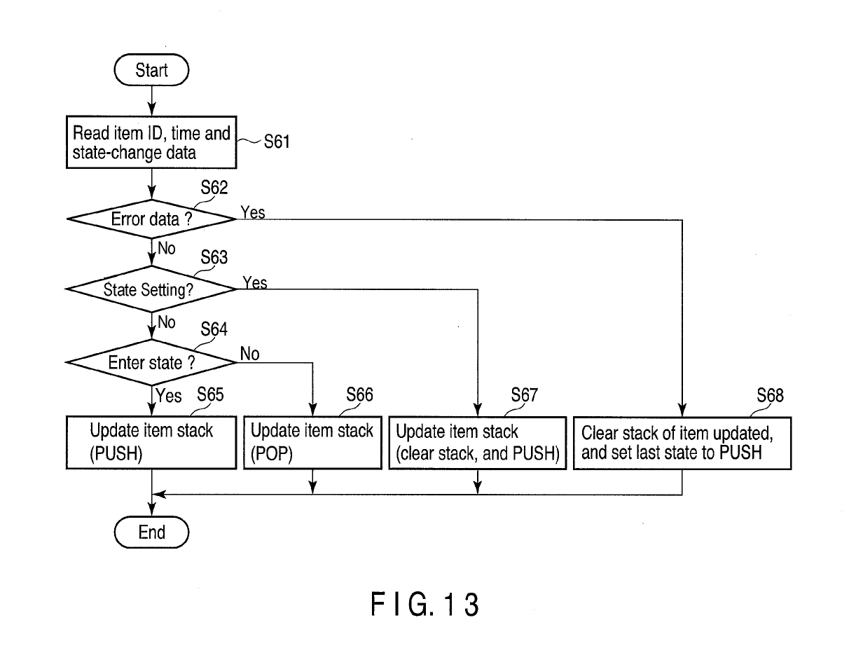

FIG. 12 and FIG. 13 are flowcharts explaining processes performed in the state display system 1 according to a second embodiment. This state display system 1 is identical in configuration to the state display system 1 according to the first embodiment, and will not be described in detail in terms of configuration.

More precisely, FIG. 12 explains the process the measuring module 410 performs in the state display system 1 according to the second embodiment.

In Step S41, the measuring module 410 specifies the present time t. In Step S42, the measuring module 410 provides a write area in the internal buffer 420.

In Step S43, the measuring module 410 determines whether the write area available in the internal buffer 420 is large enough to hold the trace data (measurement data) that should be written in the internal buffer 420. Note that the amount of the measurement data is preset or determined from the content of the data to be written as measurement data.

If the measuring module 410 determines that the write area available in the internal buffer 420 is large enough to hold the measurement data, it determines, in Step S44, whether the time (err_t) at which an error has been made is “0” or not. If err_t is “0,” the measuring module 410 writes, in Step S45, the measurement data and the time t into the internal buffer 420. More precisely, the measuring module 410 writes “time,” “item” and “state change data” into the internal buffer 420. Then, the measuring module 410 terminates the process.

In Step S43, the measuring module 410 may determine that the write area available in the internal buffer 420 is not enough to hold the measurement data. If this is the case, the measuring module 410 determines, in Step S46, whether err_t is “0” or not.

If err_t is found to be “0” in Step S46, the measuring module 410 sets err_t to time t in Step S47. Then, the measuring module 410 terminates the process. Further, the measuring module 410 stores the data (auxiliary data) representing the last state of each item, in an auxiliary data storage area provided in, for example, the main storage device 120 or provided in the register provided in the CPU 110. The measuring module 410 stores one auxiliary data piece for each item, in the auxiliary data storage area.

The item 1, for example, may enter the state A when a write error is made. In this case, the measuring module 410 stores data pieces such as “item 1” and “state A,” as auxiliary data, in the auxiliary data storage area. If the item 1 further enters the state B, the measuring module 410 overwrites data pieces such as “item 1” and “state B.” If the state of the item does not change when the write error is made, the auxiliary data will not be stored. The measuring module 410 may store the data representing “time” in the auxiliary data storage area, in addition to “item” and “state.”

In Step S44, the measuring module 410 may determine that err_t is not “0.” In this case, the measuring module 410 writes, in Step S49, err_t and the data representing the last state of the item in the internal buffer 420. That is, the measuring module 410 reads the latest state change data temporarily stored in, for example, another storage area of the main storage device 120, and writes the latest state change data into the internal buffer 420. Further, the measuring module 410 sets err_t to “0” in Step S50, and then goes to Step S42.

The output module 430 reads “time,” “item,” “state change data,” etc. from the internal buffer 420. The output module 430 then generates a management file 440 from trace data, such as “time,” “item,” “state change data,” etc. thus read. If auxiliary data is stored in the auxiliary data storage area, the output module 430 will read the auxiliary data and add the auxiliary data to the management file 440.

FIG. 13 is a flowchart explaining the data-displaying process the display module 450 performs in the state display system 1 according to the second embodiment.

To display the state of the object, the display module 450 reads, in Step S61, “time,” “item” and “state change data,” etc. from the measurement file 440.

In Step S62, the display module 450 determines whether “state change data” is error data or not.

Then, in Step S63, the display module 450 determines whether the “state change data” represents a state setting. In other words, the display module 450 determines whether the state of the item has been initialized or not.

Further, in Step S64, the display module 450 determines whether “state change data” represents that the item should “enter a certain state” (or PUSHED to a certain state).

If the “state change data” is found, in Step S64, to represent that the item should “enter a certain state,” the display module 450 updates, in Step S35, the state of the stack of the item corresponding to the “item” read from the state management data 460. That is, the display module 450 subjects the state represented by the “state change data” to PUSH, for the item that corresponds to the “item” read from the state management data 460.

If the “state change data” is not found, in Step S64, to represent that the item should “enter a certain state,” the display module 450 determines that the “state change data” represents that the subject apparatus exits from a certain state. In this case, the display module 450 goes to Step S66, in which it updates the state of the stack of the item corresponding to the “item” read from the state management data 460. That is, the display module 450 subjects the state represented by the “state change data” to POP, for the item that corresponds to the “item” read from the state management data 460.

In Step S63, the “state change data” may be found to represent a state setting. If this is the case, the display module 450 updates, in Step S67, the state of the stack of the item corresponding to the “item” read from the state management data 460. That is, the display module 450 clears the item accumulated in the “item” read, and then subjects the state represented by the “state change data” to PUSH.

The display module 450 may determine, in Step S62, that the “state change data” is error data. In this case, the display module 450 updates, in Step S68, the state of the stack of any item that changes in state when an error was made.

The display module 450 determines, from the auxiliary data added to the measurement file 440, whether the state of each item has changed due to an error. The display module 450 determines that the item contained in the auxiliary data added to the measurement file 440 is an item that changed in state when an error was made. Then, the display module 450 clears the state of the stack of any item that changed in state when an error was made.

As has been described, auxiliary data representing the last state any item assumes is added to the measurement file 440 in the state display system 1 according to the second embodiment, if the state of the item changes due to an write error resulting from, for example, a buffer overflow. The item for which the error has been made is identified on the basis of the auxiliary data added to the measurement file 440. The item, thus identified, is cleared, and the state represented by the auxiliary data is subjected to PUSH.

Thus, the state display system 1 can display the change of state, which occurs when an error is made. Moreover, the state display system 1 can hold the stack of any item for which no errors have been made, not clearing the stack of the item. The second embodiment can therefore provide a state display apparatus, a program and a state display system, all having high reliability.

In the embodiment described above, the measuring module 410 adds the auxiliary data to the measurement file 440. Nonetheless, the state display system 1 is not limited to this configuration. The auxiliary data may be recorded in any state, only if the display module 450 can be informed of the fact that the auxiliary data was recorded when an error was made.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A state display apparatus comprising:
a receiving module configured to receive measurement files associated with a device to be measured, wherein the measurement files comprise:
item data representing items executed by the device,
state-change data representing changes in the state of the items,
and time data;
storage configured to store, for each item, states of the item in a stack structure;
a display configured to display the states of the items; and
a display controller configured to erase at least one state from the stack structure of at least one of the items when the measurement files comprise error data.

2. The state display apparatus of claim 1, wherein the display controller erases the states of all the items when the measurement files comprise error data.

3. The state display apparatus of claim 2, wherein the display controller is further configured to cause the display to display an indication of an indefinite state for any item associated with a state not stored by the storage.

4. The state display apparatus of claim 1, wherein, in response to receiving a measurement file comprising error data associated with the items, the display controller is further configured to erase the state of the items

5. The state display apparatus of claim 4, wherein the measurements files can further comprise auxiliary data, and wherein the display controller pushes a state associated with the auxiliary data to stack structures associated with the items whose state has been erased.

6. The state display apparatus of claim 1, wherein the items comprise processes executed by the device.

7. A method for controlling a state display apparatus, wherein the method comprises:
receiving measurement files comprising item data associated with items executed by a device to be measured, state-change data representing changes in the state of the items, and time data;
for each item, storing states of the item in a stack structure at a storage;
determining if the measurement files comprise error data;
erasing at least one state from the stack structure of at least one of the items in response to determining that the measurement files comprise error data; and
displaying the states of the items.

8. A state display system comprising:
a measuring module configured to generate measurement files based on state changes of items executed by a device to be measured, wherein the measurement files comprise item data representing items, state-change data representing changes in the state of the items, and time data;
the measuring module further configured to generate error data in response to the occurrence of an error, wherein the state-change data further comprises the error data;
a storage configured to store, for each item, states of the item in a stack structure;
a display configured to display the states of the items; and
a display controller configured to erase at least one state of at least one of the items when the measurement files comprise the error data.

9. The state display system of claim 8, wherein the display controller erases the states of all the items when the measurement files comprise error data.

10. The state display system of claim 8, wherein the display controller is further configured to erase the state of any one of the items.

11. The state display system of claim 10, wherein the measuring module is further configured to generate auxiliary data, and wherein the display controller pushes an auxiliary state represented by the auxiliary data to stack structures associated with items whose state has been erased.
